(19) United States
(12) Patent Application Publication
(10) Pub. No.: US 2016/0337359 A1
(43) Pub. Date: Nov. 17, 2016

(54) SECURING A CONTROL SYSTEM APPLICATION LAYER PROTOCOL

(71) Applicant: HONEYWELL SPOL. S.R.O., Morris Plains, NJ (US)

(72) Inventors: Michal HOJSIK, Prague (CZ); Radomir SVOBODA, Brno (CZ)

(21) Appl. No.: 15/149,412

(22) Filed: May 9, 2016

(30) Foreign Application Priority Data
May 11, 2015 (EP) 15167169.0

(51) Int. Cl. H04L 29/06

(52) U.S. Cl. CPC H04L 63/10; H04L 63/08; H04L 63/168; H04L 63/101; H04L 63/0428

(57) ABSTRACT

Devices, methods, and systems for securing a control system application layer protocol are described herein. One method includes receiving a request at a target device from a controlling device within a session between the controlling device and a target device, securing protocol-defined ALP functions by encapsulating one or more protocol-defined ALP functions within one or more user-defined ALP functions and adding at least authentication data, receiving a plurality of user-defined ALP functions on a target device on a computing device network, and determining whether a controlling device identity or a user of a controlling device is authorized to submit a particular ALP function with particular parameters on the target device.

### TECHNICAL FIELD

The present disclosure relates to devices, methods, and systems for securing a control system application layer protocol.

### BACKGROUND

Many processes may rely on control systems to increase efficiency and/or automation, or otherwise optimize a number of operations of a physical system. Such processes may include manufacturing, production, power generation, fabrication, refining, water treatment and distribution, wastewater collection and treatment, oil and gas pipelines, electrical power transmission and distribution, wind farms, civil defense siren systems, large communication systems, heating, ventilation, and air conditioning systems (HVAC), access, and/or energy consumption, among other processes.

For various reasons, a person may launch a cyberattack against a control system. Such reasons may include cybercrime, extortion, and/or warfare, among others. The potential costs associated with an attack on processes such as gas refining, chemical manufacturing, and electric power supplying, for example, may be great.

These systems that have previously been completely isolated and based on proprietary industrial protocols, are now becoming more integrated with the corporate systems and standard IT protocols and off-the-shelf products, introducing potentially significant IT cyber security threats. However, unlike other IT systems, industrial control systems are built for usage over a long time period, have several control levels, and, when impacted, can cause widespread power outages and/or environmental disasters, among various other possibilities. This combination of factors makes the protocol security important to the overall system.

Under previous implementations of control systems, physical controls managed security threats through management of access to facilities and hard-wired control and target systems within the same facility. Further, the relative obscurity of industrial control system languages, like Modbus, limited broad knowledge of these protocols. However, implementation of control systems has changed to include remote, Internet-connected management of industrial control systems and industry usage of various software packages and products to implement these functionalities, combined with legacy systems that have few native security controls, can lead to security issues from outside parties.

### BRIEF DESCRIPTION OF THE DRAWINGS

FIG. 1 illustrates a control system in accordance with one or more embodiments of the present disclosure.

FIG. 2 illustrates multiple computing devices within a control system in accordance with one or more embodiments of the present disclosure.

FIG. 3 illustrates multiple computing devices within a control system in accordance with one or more embodiments of the present disclosure.

FIG. 4 illustrates a method for securing application layer protocols (ALPs) in accordance with one or more embodiments of the present disclosure.

### DETAILED DESCRIPTION

Devices, methods, and systems for securing a control system application layer protocol are described herein. For example, one or more embodiments include receiving a request at a target device from a controlling device within a session between the controlling device and a target device, securing protocol-defined ALP functions by encapsulating one or more protocol-defined ALP functions within one or more user-defined ALP functions and adding at least authentication data, and receiving a plurality of user-defined ALP functions on a target device on a computing device network. Embodiments further include receiving a plurality of user-defined ALP functions on a target device, and determining whether a controlling device identity or a user of a controlling device is authorized to submit a particular ALP function with particular parameters on the target device.

Control systems may be considered unique with respect to other systems in various ways. For example, a user (e.g., an administrator) overseeing a control system has an actual physical system against which the user can execute specific commands resulting in physical changes in the system.

For example, if a user logs into a controlling device and knows the target device's identity, a user can connect to that target device from any controlling device (or by simulating a controlling device) and transmit commands if the controlling device uses Modbus protocol. In this manner, a threat source may read the transmission or transmit unauthorized functions and/or commands.

For instance, if the user is not an authorized user (e.g., a threat source impersonating a legitimate user) or the authorized user attempts to transmit an unauthorized function for that user (e.g., control a setting the user is not authorized to control), the embodiments of the present disclosure can detect whether the user, device identity, a function, and/or the function's parameters are authorized; and/or, if system settings permit, authenticate, encrypt, or authenticate and encrypt the transmission of a command to the target system.

Control systems may be associated with manufacturing, production, power generation, fabrication, refining, water treatment and distribution, wastewater collection and treatment, oil and gas pipelines, electrical power transmission and distribution, wind farms, civil defense siren systems, large communication systems, heating, ventilation, and air conditioning systems (HVAC), access, and/or energy consumption, among other processes.

Securing a control system application layer protocol in accordance with one or more embodiments of the present disclosure can be implemented using an existing control system architecture, in one embodiment an industrial control system (e.g., Distributed Control Systems (DOS), Supervisory Control and Data Acquisition (SCADA), and/or programmable logic controllers (PLC)). Under previous approaches, security could be provided through additional purchases including firewalls, bump-in-the-wire devices, or creation of air gaps, among other solutions. These purchases often provided only perimeter protection, but did not effectuate a complete security control framework for control systems.

Embodiments of the present disclosure can use communication protocols used in these architectures (e.g., Modbus) to provide authentication and/or confidentiality to improve security for an existing control system architecture. The method by which messages may be authenticated and transmitted securely within legacy system communication protocols between multiple controlling and target devices enhances security of legacy systems while avoiding risks posed by inserting bump-in-the wire devices (such as network encryption devices), a substantial increase in hardware cost, or complex software upgrades.

In the course of control system operation, embodiments of the present disclosure can take various actions. Various embodiments include opening one or more security sessions and managing security sessions by one or more user-defined ALP function calls; executing, via the particular target device and within a particular session, a particular activity-related protocol-defined ALP function and corresponding command and validating whether the corresponding command is successfully transmitted without error; and, within a protocol-encapsulated session, executing the corresponding command via the particular target device and validating whether the corresponding command is successfully transmitted without error.

When security sessions may be opened and managed through ALP functions, a user on a controlling system is able to submit command messages to a target device, producing a desired effect in the target device and associated industrial machines (e.g. increasing temperature or pressure, starting a fan system). If the success of a corresponding command is transmitted to the user, whether the command is transmitted within or outside a protocol-encapsulated session, the user will move onto the next task with respect to the control system or avoid submitting the same request more than once, avoiding potentially disastrous consequences (e.g. doubling an increase of temperature or pressure of a nuclear reactor, halting an energy grid system previously started).

Additional embodiments include sending an error message and/or refusing access or command execution when a session is not open between the particular controlling device and the particular target device or when the user or device identity does not belong to an associated access control list for using a particular protocol-defined ALP function and a controlling device cannot verify the authenticity of a target device and the request. These embodiments provide a user on a controlling system the ability to send commands to a target device and for the target device to assess, according to a user-defined access control list, whether a message can be sent and if it has transmitted successfully.

Furthermore, these embodiments provide effective access control functionality for a control system by validating whether the user, the controlling device identity, or a combination of user and function/function parameters or controlling device and function/function parameters are authorized within a control system. Access control functionality limits operation of a target device and associated machines to only the users and devices authorized to execute a particular function, while target device response authenticity allows a user to determine whether a target device's response originated from the target device, rather than an individual or system attempting to pass as the target device.

An additional embodiment includes a first controlling or target device that establishes an active session with a second controlling or target device, the second controlling or target device that establishes an active session with a third controlling or target device, and third controlling or target device that establishes an active session with a fourth controlling or target device and wherein the sessions between the first and second devices and the third and fourth devices is unsecured and the sessions between the second devices and the third devices is secured. Because multiple devices may be used in a control system, a user may choose to use encrypted, authenticated, or standard connections for any transmissions between any one pair of controlling and target devices for various purposes, including between discrete device pairs in a chain control system structure (e.g., variance in cipher suites, physical proximity of controlling device to target device).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of blocks” can refer to one or more blocks.

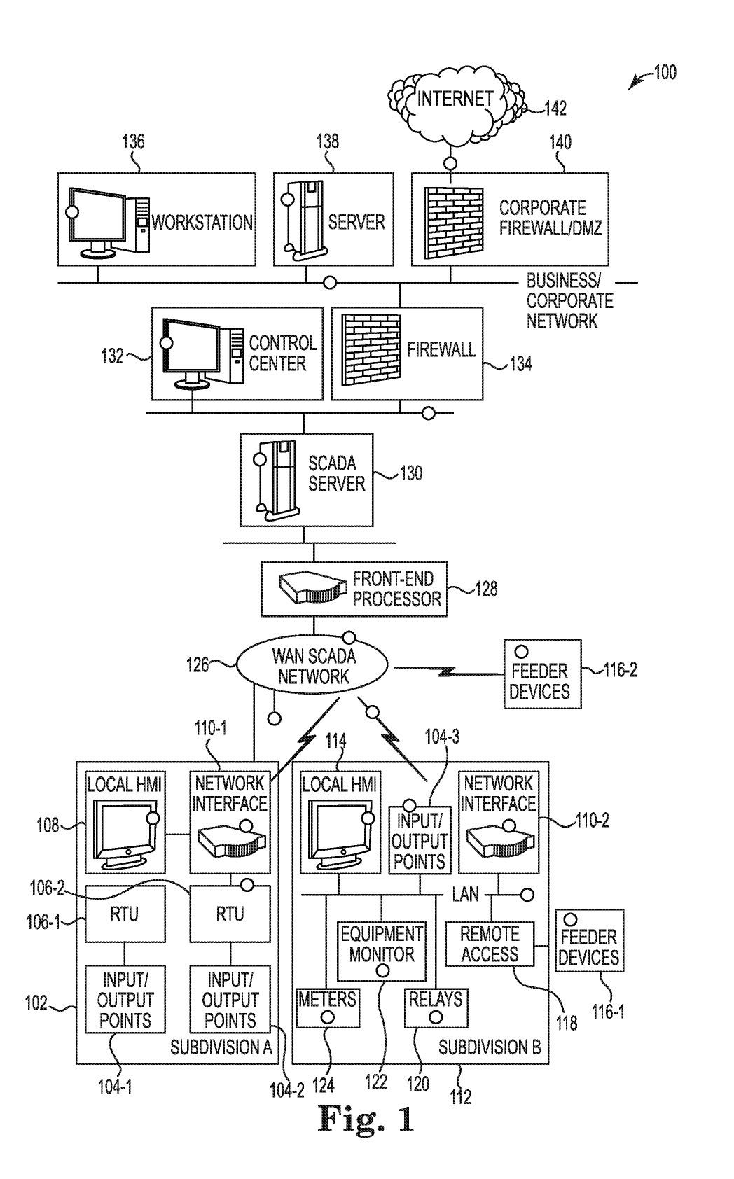

FIG. 1 illustrates a control system in accordance with one or more embodiments of the present disclosure. As shown in FIG. 1, control system 100 includes a number of input/output points (e.g., sensors and/or actuators, sometimes generally referred to herein as “sensing and/or actuating devices”). Two such input/output points: input/output points 104-1 and input/output points 104-2 (sometimes generally referred to herein as input/output points 104) are illustrated in FIG. 1, though embodiments of the present disclosure do not limit control systems to a particular number of input/output points.

As shown in FIG. 1, input/output points 104 can be included in a first subdivision 102 (e.g., subdivision A) of the components of the system 100. Input/output points 104 can be communicatively coupled (e.g., such that information can pass in either direction) to a network interface 110-1 and/or a local human machine interface (HMI) 108 via one or more remote terminal units (RTUs), shown in FIG. 1 as RTU 106-1 and RTU 106-2 (sometimes generally referred to herein as RTU 106).

In the example illustrated in FIG. 1, control system 100 includes a second subdivision 112 (e.g., subdivision B) of the components of the system 100. As shown, subdivision B includes meters 124, an equipment monitor 122, and relays 120 communicatively coupled to a local area network (LAN). Further, subdivision B includes a remote access 118 allowing communication between feeder devices 116-1 (e.g., reclosers, switch controllers, etc.) and device(s) in subdivision B. Additionally, subdivision B includes a local HMI 114, input/output points 104-3 and a network interface 110-2.

Subdivision A and Subdivision B can be connected to a wide area network 126 (e.g., WAN, SCADA network). Subdivision A and Subdivision B can communicate through network 126 and a front-end processor 128 to a server 130. A user may interact with computing device 130 via a control center 132, for instance.

Computing device 130 and/or control center 132 may be separated from business and/or corporate network device(s) by a firewall 134. Such business and/or corporate network devices can include a workstation 136, and/or a server 138, among various other devices. Workstation 136 and/or server 138 may connect to the Internet 142 through corporate firewall/demilitarized zone (DMZ) 140.

To illustrate one or more embodiments of the present disclosure, control system 100 is discussed in the following example as a control system associated with an electric power system. As previously discussed, control systems are not limited to a particular system and/or process, nor are embodiments of the present disclosure similarly limited. In this example, input/output points 104-2 (controlled by RTU 106-2) can represent a measured voltage at a particular location (inputs) and/or the actuation of one or more switches (outputs) having an effect on that voltage.

Computing device 130 can receive data from various devices of system 100 (e.g., sensing and/or actuating devices and/or their respective controllers). Data can include any data about the system that would be useful for securing the system such as, for example: status conditions (e.g., operational, standby, etc.), measured values (e.g., measurements) and/or controlled values, for instance, such as values set by one or more controllers (e.g., set points).

For example, computing device 130 can receive data from input/output points 104-2. Such data can be received according to a particular interval. Such data can be received over a particular duration and/or time period.

Computing device 130 can receive data from controller(s) associated with sensing and actuating devices (e.g., proportional-integral-derivative (PID) controllers, not shown in FIG. 1). Such data can include calculations made by such controllers locally, for instance.

It is noted that various embodiments discussed with respect to computing device 136 and 110 are illustrative. That is, while computing device 136 and 110 can carry out various embodiments, alternative or additional computing devices can be utilized.

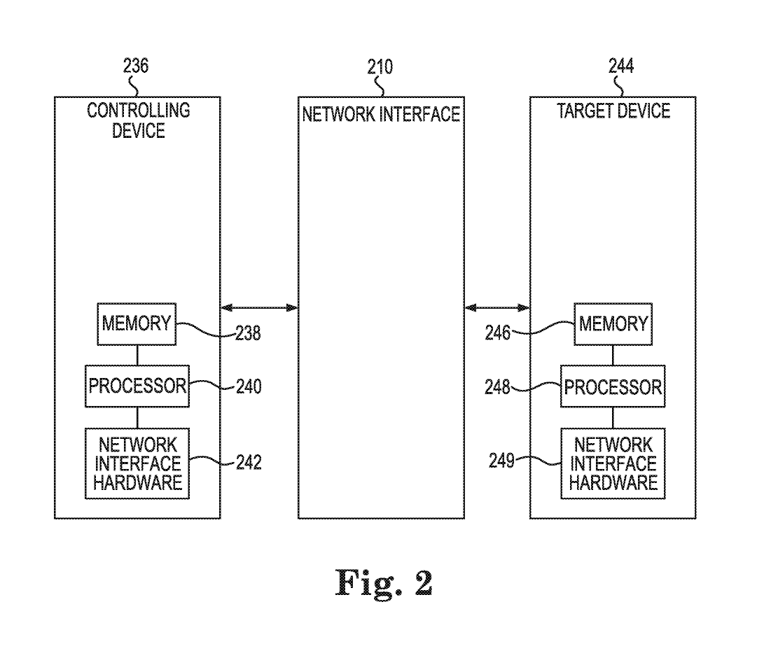

FIG. 2 illustrates multiple computing devices within a control system in accordance with one or more embodiments of the present disclosure. FIG. 2 illustrates computing devices 236, 210, and 244 for securing a control system application layer protocol representing one or more controlling devices and at least one target device, connected by a network connection.

Computing device 210 can be, for example, any network interface connecting any two computing devices enabling communication between them, which may be wireless, Ethernet-connected, or hard-wired, in accordance with one or more embodiments of the present disclosure. Computing device 236 can be a device, such as computing devices 136, 132, 130, or 108 for example, control center, HMI, a laptop computer, a desktop computer, or a mobile device (e.g., a mobile phone, a personal digital assistant, etc.) among other types of computing devices capable of transmitting a particular function instructions and/or data and controlling another device, previously discussed in connection with FIG. 1, Computing device 210 can be a device such as computing device 110-1, for instance, also previously discussed in connection with FIG. 1.

Computing device 244 represents a receiving, slave, or target device capable of receiving messages from a controlling device, and can be a device such as computing devices 108, 106-1, or 104-1. As previously discussed, computing devices used in embodiments of the present disclosure are not limited to particular devices and/or locations within control system architectures.

Computing device 244 can, for example, execute instructions at the direction of one or more devices, such as computing device 236 to, for example, transmit real-time status of pressure measurements, increase or decrease temperature, or alter electrical output for an electrical power grid, among others. Various embodiments may utilize server machine(s) within subdivisions (e.g., subdivision A, previously discussed in connection with FIG. 1).

As shown in FIG. 2, computing device 236 includes a memory 238, a processor 240 coupled to memory 238, and network interface hardware 242 that allows the computing device to communicate with other system devices (e.g., other computing devices, peripheral devices, sensors, actuators, etc.), and computing device 244 also includes a memory 246, a processor 248 coupled to memory 246, and network interface hardware 249 that functions similarly to hardware 242.

Memory 238 and 246, respectively, can be any type of storage medium that can be accessed by processor 240 and 248, respectively, to perform various examples of the present disclosure. For example, memory 238 and 246 can be a non-transitory computer readable media having computer readable instructions (e.g., computer program instructions) stored thereon that are executable by processor 240 and 248 to secure control system application layer protocol in accordance with one or more embodiments of the present disclosure.

Memory 238 and 246 can be volatile or nonvolatile memory. Memory 238 and 246 can also be removable (e.g., portable) memory, or non-removable (e.g., internal) memory. For example, memory 238 and 246 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Memory 238 and 246 may, for example, store parameters or configurations specific to data objects, defined flags corresponding to field bits, or memory addresses among other items. With respect to embodiments of the present disclosure, for example, a unique user key, seed S, initialization counter, or other session-related information may be written to non-volatile or volatile memory to enable use of security-related function instructions and/or data, set specific security levels, validate message legitimacy, or to authorize one or more controlling devices among other uses.

Further, although memory 238 and 246 is illustrated as being located in computing device 236 and 244, respectively, embodiments of the present disclosure are not so limited. For example, memory 238 and 246 can also be located internal to another computing resource (e.g., enabling computer readable instructions to be downloaded over the Internet or another wired or wireless connection).

FIG. 2 includes devices 236 and 244, which represent one or more controlling devices and at least one target device communicating via an ALP that, in addition to having a set of protocol-defined ALP functions, includes a set of one or more specialized user-defined ALP functions, wherein one or more of the set of specialized ALP functions within the set of user-defined ALP functions provide user or device authentication. Such ALP functions are housed within the memory for these devices, 238 and 246, respectively, which include non-user-defined function instructions and/or data and function instructions and/or data which may be defined by a user.

User-defined function instructions and/or data provide user or device authentication when one or more of the protocol-defined ALP functions are encapsulated within at least one user-defined ALP function along with authentication data. User-defined ALP function instructions and/or data can encapsulate both user-defined and non-user-defined ALP function instructions and/or data, transmitting the function instructions and/or data and associated command or message between devices 236 and 244 (e.g. function instructions and/or data 15—write multiple coils) with authentication data.

The authentication data allows for verification of the authenticity and/or integrity of a received request, when at least one target device performs a requested ALP function call and transmits an authenticated response; and the one or more controlling devices is configured to verify response authenticity using authentication data. Authentication data transmitted with a function instructions and/or data and message or command allows both the target device and the controlling device to verify a request and response from the other device. This verification allows a device and user of that device to determine if the other user or device is legitimate, i.e. not another system or individual unauthorized to transmit functions that has intercepted communication on network interface 210, which may have limited network security installed in some circumstances.

In other embodiments, the user or device identity authentication and data authentication is performed by symmetric or asymmetric cryptography; a particular controlling device and a particular target device determine a highest shared protocol version to be used in future interactions between the two devices and determine an authentication or encryption method and associated ciphers to be used for protocol encapsulation; or the data transmitted are not only authenticated but also encrypted function instructions and/or data. Subsequently all communicated (potentially encrypter) data ALP are accompanied by authentication data, preventing unauthorized systems or users from reading transmissions across network interface 210. The method of transfer may also include authentication only or encryption only, depending on the user's choice of transfer method or the highest protocol version available to devices 236 and 244.

In an embodiment of the present disclosure, at least one target device references an access control list to verify whether a particular user or device identity of a particular controlling device is authorized to perform one or more functions or perform functions for requested parameters. While authentication data allows a device, such as device 236 or 244, and a user of that device, to verify the authenticity of a function instructions and/or data, an additional embodiment also allows a target device 244 to reference an access control list within memory 246 to verify the user ID or identifying information of the controlling device. The verification of the user and the device further safeguards functions submitted by combining both device authentication with user and device access controls,

In additional embodiments of the present disclosure, message authentication uses a reply-attack protection mechanism and a message authentication code or signature computation to ensure the legitimacy of a particular command within a particular session. In a reply attack, an attacker can intercept messages and reply with these messages at a later time. However, in the present embodiment, a message counter and message authentication code enables a device to determine whether the function instructions and/or data and associate message or command has been sent by the user and device within the order it should have been sent (e.g. if a message is received by a target device out of order, the target device can determine that target device should not execute on the transmitted message).

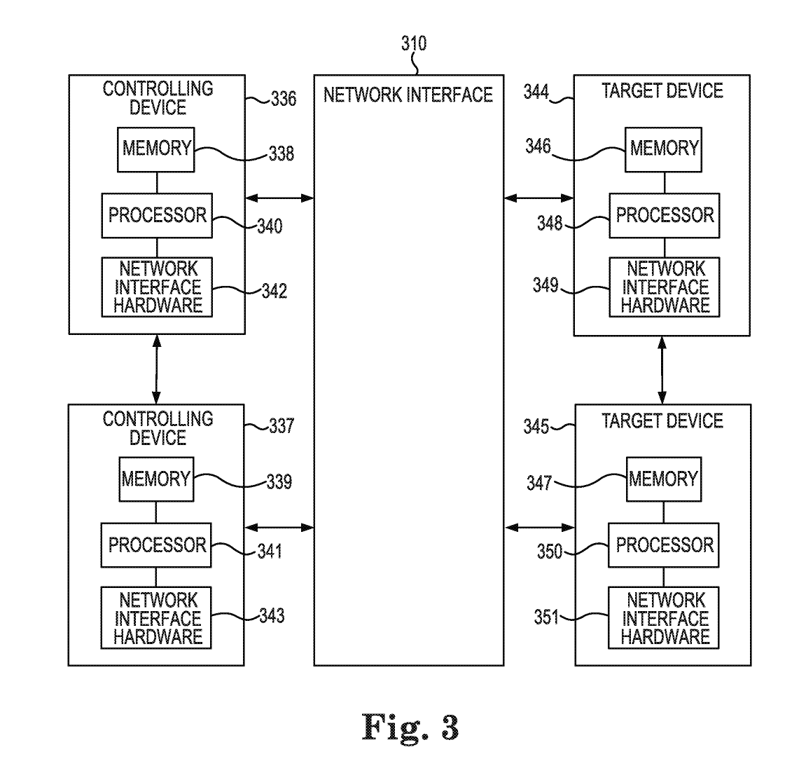

FIG. 3 includes devices 336, 337, 344, and 345, which represent one or more controlling devices and at least one target device communicating via an ALP that, in addition to having a set of protocol-defined ALP functions within the ALP, includes a set of one or more specialized user-defined ALP functions within the ALP, wherein one or more of the set of specialized ALP functions within the set of user-defined ALP functions provide one or more functions to secure communication. Such ALP functions are housed within the memory for these devices, 338, 339, 346 and 347, respectively, which include protocol-defined function instructions and/or data and function instructions and/or data which may be defined by a user, similar to the function of 238 and 246, respectively.

User-defined functions provide user or device authentication when one or more of the protocol-defined ALP functions are encapsulated within at least one user-defined ALP function along with authentication data, which enables any two devices to encrypt, authenticate, encrypt and authenticate, or not encrypt or authenticate transmissions of user-defined and non-user-defined ALP functions. Because any two devices determine whether or not authentication or encryption are used, a control system exhibits flexibility with regard to the security of specific devices within the control system when a user can determine whether any two devices create or do not create a particular type of secure session.

For example, a system may include hard-wired controlling and target devices housed at one physical location (e.g. devices 336 and 344), with a connection between a single controlling device 337 housed at one physical location and a single target device 345 at another physical location, communicating through a network interface 310. A user may prefer to encrypt the transmission between controlling device 337 and target device 345 due to it passing through network interface 310, a connection that might increase the probability of an attacker intercepting the transmission, using an intercepted message in a reply attack, or directly communicating with (i.e. controlling) the target device.

The industrial control system also includes wherein the at least one target device is configured to verify the authenticity of a received request using the authentication data and wherein the at least one target device performs a requested ALP function and transmits an authenticated response. Authentication data transmitted with a function instructions and/or data and message or command allows a target device 345 to verify a request/command from another device, such as devices 336, 344, and 337.

This verification allows the target device and/or a user of that device to determine if another user or device is legitimate. Further, the industrial control system includes the one or more controlling devices 336 and/or 337, which are configured to verify response authenticity using the authentication data. This configuration for a controlling device, similar to target device 345 verifying a request using authentication data, allows a controlling device 336 to verify the authenticity of communication from devices 337, 344, and 345.

The industrial control system further includes one or more of the protocol-defined ALP functions, which are contained within at least one user-defined ALP function along with authentication data to provide the secure communication session. In one embodiment, a user-defined ALP function and matching cipher suites at memory 339 and 347 allows for encapsulation of communication between a controlling device 337 and a target device 345, and transmits a protocol-defined ALP function (e.g. Modbus Read Holding Registers function 03), using a user-defined, encrypted connection between devices and passing authentication data between devices 337 and 345. This capability allows any two devices of an industrial control system utilizing a secured application layer protocol to transmit protocol-defined ALP functions securely via user-defined ALP functions that encapsulate and authenticate transmitted commands and messages.

The industrial control system further includes a first controlling or target device that terminates an active communication session with a second controlling or target device, the second controlling or target device terminates an active communication session with a third controlling or target device, and third controlling or target device terminates an active communication session with a fourth controlling or target device and wherein the sessions between the first and second devices and the third and fourth devices is unsecured and the sessions between the second devices and the third devices is secured. In an industrial control system, multiple devices may be used, and the number, location, and capabilities of such devices may differ significantly between industries.

As such, the need for encrypted or authenticated communication may differ based on industry, location, device type, or the category of machines involved. These multiple devices may be connected to one another in a matrix or chain-like fashion, and in any arrangement include the ability for any two devices to create a secured session, while other devices in the system may not create a secured session. In this arrangement, all sessions may be terminated regardless of the nature of such sessions (secured or not secured).

In one embodiment, wherein the first, second, third, and fourth devices 336, 337, 344, and 345 all communicate using the same set of protocol-defined ALP functions in memory 338, 339, 346, and 347, all devices can create secure sessions. In another embodiment, wherein only the second and third devices 337 and 344 communicate using the set of user-defined ALP functions in memory 339 and 346 that provide one or more functions to secure the communication session between the second and third devices, only a subset of devices in the system can create secure sessions.

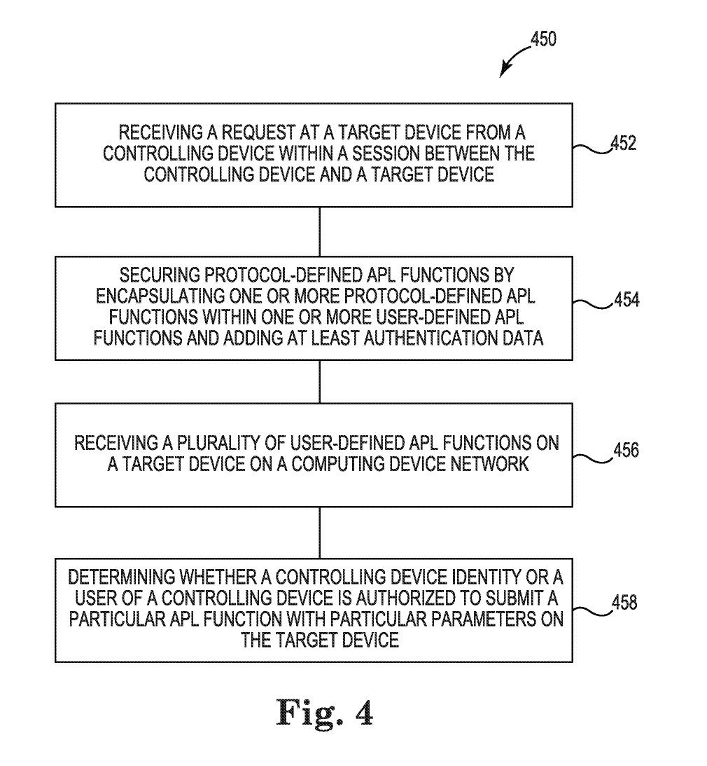

FIG. 4 illustrates a method for securing a control system Application Layer Protocol (ALP) in accordance with one or more embodiments of the present disclosure. In the embodiment of FIG. 4, the method includes, receiving a request at a target device from a controlling device within a session between the controlling device and a target device, at block 452. Method 450 can be performed, for example, by one or more controlling and at least one target computing devices within an industrial control system, such as computing devices 236 and 244, discussed in connection with FIG. 2.

At block 454, method 450 includes securing protocol-defined ALP functions by encapsulating one or more protocol-defined ALP functions within one or more user-defined ALP functions and adding at least authentication data. A user directs the capsulation of protocol-defined

ALP functions by choosing a user-defined ALP function instructions and/or data within memory 338, 339, 346, and 347 to create a secure session for communication between any two devices, such as devices 336, 337, 344, and 345, discussed in connection with FIG. 3.

The embodiment also includes receiving a plurality of user-defined ALP functions on a target device on a computing device network, at block 456. In one embodiment, user-defined ALP functions may be created by a user within memory 338, 339, 346, and 347 of devices 336, 337, 344, and 345, in FIG. 3, and include particular user-defined ALP functions enabling the creation of a secure session between any two devices.

At block 458, method 450 includes determining whether a controlling device identity or a user of a controlling device is authorized to submit a particular ALP function with particular parameters on the target device. In some embodiments, an access control list is included in the memory 238 and 246 of devices 236 and 244, as described in connection with FIG. 2.

Such an access control list allows a user to determine which users, device identities, or functions (or combination thereof) are allowed to create a session,communicate with a device, or trigger some result within another device and/or connected machine. For example, a user may have access to a target device, but the controlling device identity has not been given permissions to the target device on the access control list; a user and controlling device identity may have permissions on the access control list, but the function instructions and/or data transmitted is not permitted for the user or controlling device identity; or the user, controlling device identity, and function instructions and/or data are allowed via the access control list, yet the parameters of a transmitted command associated with a function instructions and/or data exceed allowable parameters. Each of these scenarios allow a user to designate which actions are permitted with respect to a device, securing a system by restricting certain behaviors to those defined by a user on a device's access control list.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for securing application layer protocols (ALP), comprising:
receiving a request at a target device from a controlling device within a session between the controlling device and a target device;
securing protocol-defined ALP functions by encapsulating one or more protocol-defined ALP functions within one or more user-defined ALP functions and adding at least authentication data;
receiving a plurality of user-defined ALP functions on a target device on a computing device network;
determining whether a controlling device identity or a user of a controlling device is authorized to submit a particular ALP function with particular parameters on the target device;

2. The method of claim 1, wherein one or more of the target devices and one or more of the controlling devices is associated with an industrial control system.

3. The method of claim 2, wherein the industrial control system utilizes a Modbus protocol.

4. The method of claim 1, wherein the method includes opening one or more security sessions and managing security sessions by one or more user-defined ALP function calls.

5. The method of claim 4, wherein the method includes sending an error message when a session is not open between the particular controlling device and the particular target device or when the user or device identity does not belong to an associated access control list for using a particular protocol-defined ALP function.

6. The method of claim 1, wherein the method includes executing, via the particular target device and within a particular session, a particular activity-related protocol-defined ALP function and corresponding command and validating whether the corresponding command is successfully transmitted without error.

7. The method of claim 6, wherein the method further includes, within a protocol-encapsulated session, executing the corresponding command via the particular target device and validating whether the corresponding command is successfully transmitted without error.

8. The method of claim 1, wherein the method further includes sending an error message when a particular user or device identity is not listed on an associated access control list for a particular protocol-defined function.

9. The method of claim 1, wherein the method further includes a first controlling or target device that establishes an active session with a second controlling or target device, the second controlling or target device that establishes an active session with a third controlling or target device, and third controlling or target device that establishes an active session with a fourth controlling or target device and wherein the sessions between the first and second devices and the third and fourth devices is unsecured and the sessions between the second devices and the third devices is secured.

10. The method of claim 1, wherein the controlling device verifies authenticity of a target device response.

11. An industrial control system utilizing a secured application layer protocol (ALP), comprising:
one or more controlling devices and at least one target device communicating via an ALP that, in addition to having a set of protocol-defined ALP functions, includes a set of one or more specialized user-defined ALP functions, wherein one or more of the set of specialized ALP functions within the set of user-defined ALP functions provide user or device authentication;
one or more of the protocol-defined ALP functions are encapsulated within at least one user-defined ALP function along with authentication data;
wherein the at least one target device is configured to verify the authenticity of a received request using the authentication data;
wherein the at least one target device performs a requested ALP function call and transmits an authenticated response; and
the one or more controlling devices is configured to verify response authenticity using the authentication data.

12. The system of claim 11, wherein the at least one target device references an access control list to verify whether a particular user or device identity of a particular controlling device is authorized to perform one or more functions or perform functions for requested parameters.

13. The system of claim 11, wherein the user or device identity authentication and data authentication is performed by symmetric or asymmetric cryptography.

14. The system of claim 11, wherein message authentication uses a reply-attack protection mechanism and a message authentication code or signature computation to ensure the legitimacy of a particular command within a particular session.

15. The system of claim 11, wherein the data transmitted are not only authenticated but also encrypted.

16. The system of claim 11, wherein a particular controlling device and a particular target device determine a highest shared protocol version to be used in future interactions between the two devices.

17. The system of claim 11 wherein a user operating a controlling device determines an authentication or encryption method and associated ciphers to be used for protocol encapsulation.

18. An industrial control system utilizing a secured application layer protocol (ALP), comprising:
one or more controlling devices and at least one target device communicating via an ALP that, in addition to having a set of protocol-defined ALP functions within the ALP, includes a set of one or more specialized user-defined ALP functions within the ALP, wherein one or more of the set of specialized ALP functions within the set of user-defined ALP functions provide one or more functions to secure a communication session;
wherein the at least one target device is configured to verify the authenticity of a received request using the authentication data;
wherein the at least one target device performs a requested ALP function call and transmits an authenticated response; and
the one or more controlling devices is configured to verify response authenticity using the authentication data;
one or more of the protocol-defined ALP functions are contained within at least one user-defined ALP function along with authentication data to provide the secure communication session; and
a first controlling or target device that terminates an active communication session with a second controlling or target device, the second controlling or target device terminates an active communication session with a third controlling or target device, and third controlling or target device terminates an active communication session with a fourth controlling or target device and wherein the sessions between the first and second devices and the third and fourth devices is unsecured and the sessions between the second devices and the third devices is secured.

19. The system of claim 18, wherein the first, second, third, and fourth devices all communicate using the same set of protocol-defined ALP functions.

20. The system of claim 18, wherein only the second and third devices communicate using the set of user-defined ALP functions that provide one or more functions to secure the communication session between the second and third devices.
